(19) United States
(12) Patent Application Publication
(10) Pub. No.: US 2005/0148426 A1
(43) Pub. Date: Jul. 7, 2005

(54) Variable speed transmission having a continuously variable toroidal drive

(76) Inventor: Steffen Henzler, Bobingen/Rems (DE)

Correspondence Address: KLAUS J. BACH, 4407 TWIN OAKS DRIVE, MURRYSVILLE, PA, 15668, US

(21) Appl. No.: 11/037,397

(22) Filed: Jan. 18, 2005

Related U.S. Application Data
(63) Continuation-in-part of application No. PCT/EP03/00695, filed on Jun. 25, 2003.

(30) Foreign Application Priority Data
Jul. 19, 2002 (DE) 102 33 091.3

(51) Int. Cl. F16H 15/38

(52) U.S. Cl. 476/10; 476/40

(57) ABSTRACT

In a variable speed transmission comprising a toroidal drive for continuously changing the gear ratio, improved means for applying the contact force between a roller and the toroidal disks of a toroidal drive are provided in that a rear side of the axially displaceable torus disk forms a piston which is hydraulically activated by a pressure generated by a control spool valve to which the initial pressure of an electric control valve is supplied as control pressure.

This is a Continuation-In-Part Application of International Application PCT/EP2003/00695 filed Jun. 25, 2003 and claiming the priority of German patent application 102 33 091.3 filed Jul. 19, 2002.

### BACKGROUND OF THE INVENTION

The invention relates to a variable speed transmission, in which a continuously variable toroidal drive is arranged in the force flux between an input shaft and an output shaft of the transmission.

In continuously variable transmissions, a drive torque is transmitted via frictional contact engagement of drive elements, along with a variation in the radius of the engagement. For this purpose, the application of a pressure force is required so that the necessary contact forces can be generated.

For continuously variable wrap-around transmissions, which differ from the subject of the present invention because of the changed contact conditions, it is known from DE-A 28 53 028 to apply the pressure force, on the one hand, by means of a potential energy accumulator, that is a spring. The spring in this case ensures a basic pressure exerted on the friction partner involved. On the other hand, a further component of the pressure force is ensured by means of a force generator actuated by pressure medium, here a piston/cylinder assembly.

Furthermore, the use of a hydraulic device for changing the radii of friction engagement by pivoting a roller arranged between a driving toroidal disk and a driven toroidal disk is known from DE 197 33 660 A1.

The object of the present invention is to provide a variable speed transmission having a continuously variable toroidal drive, which possesses optimized means for applying the pressure force required for generating the frictional engagement forces.

### SUMMARY OF THE INVENTION

In a variable speed transmission comprising a toroidal drive for continuously changing the gear ratio, improved means for generating the contact force between a roller and the toroidal disks of a toroidal drive in that a rear side of the axially displaceable torus disk forms a piston which is hydraulically activated by a pressure generated by a control spool valve to which the initial pressure of an electric control valve is supplied as control pressure.

The variable speed transmission according to the invention includes a continuously variable toroidal drive arranged in the force flux between an input shaft and an output shaft. In addition to this toroidal drive, further gear groups may be provided in the variable speed transmission. The variable speed transmission is, in particular, a power-split transmission having a plurality of operating ranges.

The continuously variable toroidal drive possesses at least one toroidal drive disk, at least one driven toroidal disk and at least one roller which is compressed by a pressure force between the driving and the driven toroidal disks. Transmission of a drive torque of a drive assembly from the driving toroidal disk to the driven toroidal disk takes place by means of the roller. The transmission ratio can be varied continuously as a result of a variation in the radius of engagement of the roller with the driving or driven toroidal disk. Such a toroidal-type variable speed wheel may have one or more chambers connected in series and therefore with one or more driving and driven toroidal disks and also rollers.

At least one toroidal disk is mounted so as to be axially displaceable. The displacement freedom serves for implementing a pressure force between the toroidal disks and the roller. The displaceable toroidal disk is capable of being acted upon by a pressure force. The pressure force is generated at least partially by means of a hydraulic piston, on the piston surface of which a hydraulic pressure acts. The transmission of the pressure force to the toroidal disk may take place indirectly, for example, via mechanical connecting elements, or directly, that is by direct action of the hydraulic pressure on the toroidal disk.

According to the invention, the hydraulic pressure is the control pressure of a control spool valve. The use of a control spool valve for ensuring (at least part of) the pressure force of a toroidal-type variable speed transmission is an especially effective, reliable and simple way of ensuring the pressure force. In this case, control spool valves known per se and produced in large quantities may be used. It is advantageous, furthermore, that, with a suitable selection of the surface ratios of the control spool of the control spool valve, a higher control pressure can be provided accurately using a lower control fluid pressure. The outlay for control, for example by means of control devices of small dimensions can thereby be minimized.

According to a particular embodiment of the invention, the control pressure is provided by a solenoid control valve. Solenoid control valves of this type are especially advantageous with regard to the costs and the regulation quality, since the hydraulic signal can be preset accurately and rapidly by presetting an electrical signal.

In another embodiment of the variable speed transmission according to the invention, a spring device is provided which applies at least part of the pressure force at least in part-operating ranges of the variable speed transmission in a parallel or series connection with the hydraulic pressure. This is advantageous especially when, even if there is no hydraulic pressure available as for example during starting of the drive assembly, a minimum pressure force which can be provided by the spring device is required. Moreover, the spring device can provide a minimal or permanently necessary force. The spring device may take effect to provide assistance to the hydraulic pressure, so that the devices necessary for ensuring the hydraulic pressure can be relatively small.

Preferably, the hydraulic pressure acts directly on the toroidal disk. In this case, the toroidal disk forms, in particular on the side located opposite the roller, a hydraulic piston which is acted upon by the hydraulic pressure. This results in an especially compact arrangement and in a particularly direct application of the pressure force to the toroidal disk. In a particular development of the invention, a spring applying part of the pressure force is arranged in a pressure space which is formed by means of the displaceable piston and a working cylinder. An especially compact arrangement is thereby obtained.

According to an advantageous embodiment of the variable speed transmission, the hydraulic pressure is fed back to the control spool of the control spool valve. According to this refinement of the invention, there is no need for a measuring sensor for detecting the hydraulic pressure. By the hydraulic pressure being fed back to the control spool, the conditions at the control spool can be influenced in an automated way in the event of a variation of the control pressure, so that self-adjustment takes place.

The invention will become more readily apparent from the following description thereof on the basis of the accompanying drawings. Preferred exemplary embodiments of the variable speed transmission according to the invention are explained in more detail below with reference to the drawing in which:

### BRIEF DESCRIPTION OF THE DRAWINGS

FIG. 1 shows an embodiment of a variable speed transmission according to the invention in a diagrammatic illustration in half section,

FIG. 2 is in a partial sectional view of a variable transmission according to the invention with a parallel connection of the potential energy accumulator and of the force generator actuated by pressure medium,

FIG. 3 is in a part sectional view a variable speed drive with a series connection of the potential energy accumulator and of the force generator actuated by pressure medium,

FIG. 4 shows a basic arrangement of a hydraulic system for acting upon the force generator actuated by pressure medium, with a solenoid valve and with a control spool, and

FIG. 5 shows an exemplary friction characteristic curve of the contact medium between a roller and toroidal disks as a function of the pressure force.

### DESCRIPTION OF A PREFERRED EMBODIMENT OF THE INVENTION

The invention is used in variable speed transmissions is particular for motor vehicles. The variable speed transmission is a single-range or multi-range transmission with or without power split and with or without a direct gear.

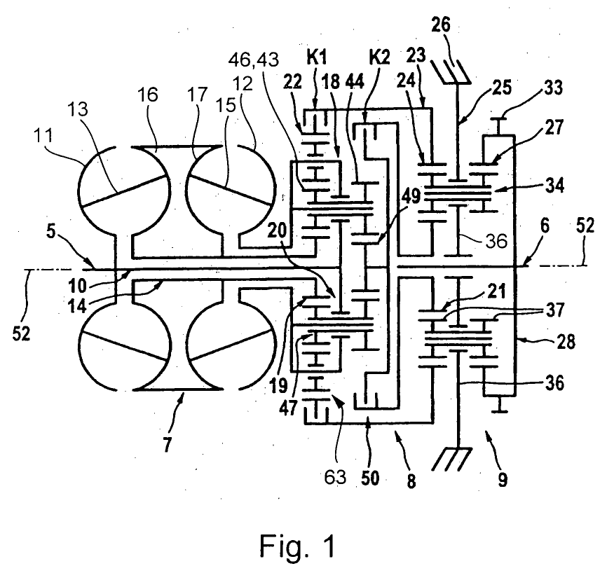

According to FIG. 1, a continuously variable toroidal drive 7, an epicyclic intermediate gear 8 and an epicyclic output gear 9 are arranged in force flux between an input shaft 5 drivable in the conventional way by an engine and an output shaft 6 couplable in the conventional way to the vehicle wheels of a motor vehicle.

The input shaft 5 is connected for rotation with the adjacent toroidal central drive disk 11 of the toroidal drive 7 and, via a coaxial central intermediate shaft 10, to a two-web planet carrier 18 of the intermediate drive 8. The planet carrier 18 in turn, is connected for rotation with the second central toroidal drive disk 12 of the toroidal drive 7. The drive disk 12 is arranged adjacent the planet carrier 18 and is connected for rotation with the first drive disk 11. A concentric intermediate shaft 14, which is arranged coaxially to the common geometric axis of rotation 52-52 of the input and output shafts 5 and 6 and through which the central intermediate shaft 10 passes with play, is connected fixedly for rotation with the two central toroidal driven disks 16 and 17 of the toroidal drive 7 which are arranged adjacent to one another. The intermediate shaft 14 is also connected firmly for rotation with an inner central gear 19 of the intermediate transmission 8. In a way conventional in toroidal drives, the driving disk 11 or 12 is in frictional contact with its associated driven disk 16 or 17 via circular disk shaped planets, known as rollers 13 and 15, which are arranged in each case rotatable about a specific axis of rotation and pivotable about a pivot axis perpendicular to their axis of rotation, but otherwise so as to be invariable in position with respect to the central axis, coinciding with the axis of rotation 52-52 of the toroidal drive 7.

The inner central drive web 20 contains main planets 46 mounted on one web of the planet carrier 18 of the intermediate transmission gear 8, with gear rings 43 which are arranged on both sides of a radial drive web 20 of the planet carrier 18 of which one toothed ring 43 meshes with the inner central wheel 19 connected to the concentric intermediate shaft 14 and the other gear ring 44 meshes with a second inner central wheel 49, which is arranged axially at the other side of the radial drive web 20 and which finally, in turn, has a drive connection 50 containing an engageable and disengageable clutch K2 for engagement with the inner central wheel 21 forming the first gear member of the output gear arrangement. The gear ring 43 meshing with the one inner central gear 19 of the intermediate gear structure 8 of the main planet 46 is additionally in meshing engagement with a secondary planet 63 which is mounted on the second web of the planet carrier 18 and which itself meshes with an outer ring gear 22, which has a drive connection 23 containing an engageable and diengageable clutch K1 to a ring gear 24 forming a second gear member of the output gear structure 9.

The output gear structure 9 has a third gear member in the form of a planet carrier 25 which is secured non-rotatably with respect to a non-rotating casing part 26 by means of a radial supporting web 36 and which supports planet wheels 34 with two gears 37 with the same number of teeth, which are arranged at opposite sides of supporting web 36 and of which one toothed gear 37 which is disposed adjacent to the intermediate gear structure 8 meshes both with the inner and with the outer gear wheel 21 and 24.

The output gear structure 29 has a fourth gear member in the form of a second outer gear ring 27 which meshes with the other gear 37 of the planet gears 34 and which has a drive connection 28 to the output shaft 6.

A parking locking wheel 33 is arranged concentrically and fixedly in terms of movement to the outer circumference of the outer central gear 27.

In the lower driving range, the clutch K1 is engaged and the clutch k2 id disengaged, so that the power is transmitted split via the intermediate shafts 10, 14 to the intermediate gear structure 8 and, combined again in the latter, and then transferred to the output shaft 6 via the drive connection 23 and the output gear structure 9 which is in this case has the division ratio 1:1.

The gears 44 and 45 of the main planet 47 in the intermediate gear structure 8 may have identical or different numbers of teeth. The transmission ratio in the upper driving range can be varied via a variation in the ratio of the numbers of teeth of the gears 44 and 45.

Other aspects of variable speed transmissions which can easily be combined with the features according to the invention are generally known and disclosed for example in the publications DE 100 21 912, DE 100 40 126, DE 200 224 53, DE 100 40 039, DE 100 30 779, DE 101 32 674, DE 101 21 042, DE 101 25 817, DE 102 02 754, DE 101 54 095, DE 101 54 928, DE 102 18 356 and DE 102 06 202.

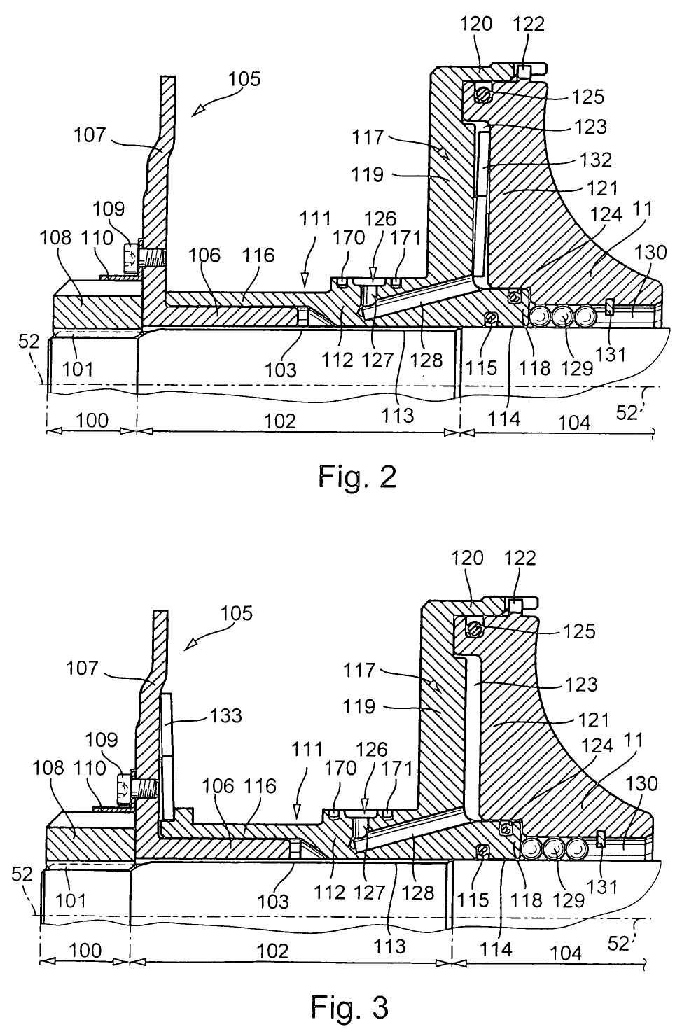

FIGS. 2 and 3 shows exemplary embodiments of a rotationally fixed connection of a toroidal disk to a shaft, with the possibility of applying an engagement force oriented in the direction of the axis 52-52 to the toroidal disk. The embodiments serve to ensure frictional contact between the toroidal disks and at least one roller. According to the exemplary embodiments illustrated in FIGS. 2 and 3, the principle according to the invention is illustrated by way of example by means of the connection of the driving toroidal disk 11 to the input shaft 5.

The drive shaft 5 possesses, in a region 100 facing the drive assembly, an external thread 101, a part region 102 adjoining the latter in the direction toward the intermediate gear structure 8 and having a splined toothing 103, the outside diameter of which is enlarged slightly with respect to the thread 101, and a cylindrical part region 104 adjoining the part region 102.

Connected fixedly in terms of rotation to the part region 102 is a flange 105 which has a hub 106 and a flanged disk 107 oriented transversely to the axis 52-52. The hub 106 has an internal geometry designed to match the external geometry of the part region 102, so that the shaft 5 and the hub 106 form a rotationally fixed connection. The flange 105 is supported axially in the direction of the drive assembly on a shaft nut 108 which is screwed onto the thread 101. In addition to the function of securing the flange 105 axially, an exact positioning of the flange 105 can be carried out via the shaft nut 108. A screw 109 screwed into the flanged disk 107 carries a securing means 110 for fixing the shaft nut 108.

An intermediate carrier 111 is arranged coaxially with the axis 52-52 and has a hub 112. The hub 112 has an inner splined toothing 113 which a cylindrical bore 114 adjoins in the direction toward the gear structure 8. The splined toothing 113 forms a rotationally fixed connection with the splined toothing 103. In the region of the bore 114, a sealing element 115 is arranged which seals off the hub 112 with respect to the drive shaft 5 in the part region 104. In that end region of the hub 112, which faces away from the intermediate gear structure 8, the intermediate carrier 111 has a hollow-cylindrical extension 116, via which the intermediate carrier 111 is supported in the axial direction with respect to the flanged disk 107. The extension 116 surrounds the hub 106 so as to form a clearance or transition fit.

The intermediate carrier 111 possesses a working cylinder 117 having a U-shape in the part cross-section illustrated in FIG. 2. The U-shaped cross-section (extending around the axis 52-52) of the working cylinder is formed by means of an inside leg 118 formed by the hub 112, an (annular) base leg 119 oriented transversely to the axis 52-52 and an outside leg 120. The working cylinder 117 is open toward the direction of the intermediate gear structure 8.

The driving toroidal disk 11 has, in the end region facing the drive assembly, an (annular) piston 121 which is received in the working cylinder 117 in such a way that, via a tooth engagement 122 between the side leg 120 and the outer surface of the driving toroidal disk 11, the driving toroidal disk 11 and the working cylinder 117 are connected to one another fixedly in terms of rotation, but are axially displaceable, and that the piston 121 forms with the working cylinder 117 a working space 123 which is sealed off in the region of the side legs 118, 120 by means of sealing elements 124, 125. The sealing element 124 is received in an outer annular groove of the hub 112 and is operatively engaged with the piston 121 in the region of an inner cylindrical surface area of the latter. The sealing element 125 is received in a radially outer annular groove of the piston 121 and is operatively engaged with the side leg 120.

The working space 123 is connected hydraulically to a hydraulic connection 126. The hydraulic connection 126 is an annular groove by way of which a hydraulic medium can be supplied when the intermediate carrier 111 is rotating. The hydraulic connection 126 is arranged preferably in the region of the hub 112 and is sealed off by means of two sealing element 170, 171. According to FIG. 2, communication of the hydraulic connection 126 with the working space 123 takes place by way of a blind bore 127, extending from the hydraulic connection 126 and oriented transversely to the axis 52-52, and a blind bore 128, inclined at an acute angle to the axis 52-52, from the working space 123 in the direction of the drive assembly, the blind bores 127, 128 being joined at their end regions. In the case of a rotationally fixed connection of the drive shaft 5 to the driving toroidal disk 11, the driving toroidal disk 11 can be acted upon by a pressure force axially in the direction toward the intermediate gear structure 8 by the action of pressure established in the working space 123. The driving toroidal disk 11 is supported radially on the inside of the latter with respect to the drive shaft 5 via ball bearings 129. To ensure play 130, the balls of the ball bearing 129 are guided in the axial direction between the end face of the hub 112 and a securing ring 131 arranged radially on the inside of the driving toroidal disk 11.

One (or more) axially acting spring element(s) is(are) arranged in the working space 123. According to the exemplary embodiment illustrated in FIG. 2, the spring element is a cup spring 132 which is arranged coaxially with the axis 52-52.

According to the exemplary embodiment illustrated in FIG. 3, a spring element 133 is arranged between the extension 116 and the flanged disk 107, so that the spring element 133 causes a displacement of the intermediate carrier 111 and consequently of the driving toroidal disk 11 in the direction toward the intermediate gear structure 8. With the additional action of pressure upon the working space 123, the hydraulic force and the force of the spring element 133 act mechanically in parallel.

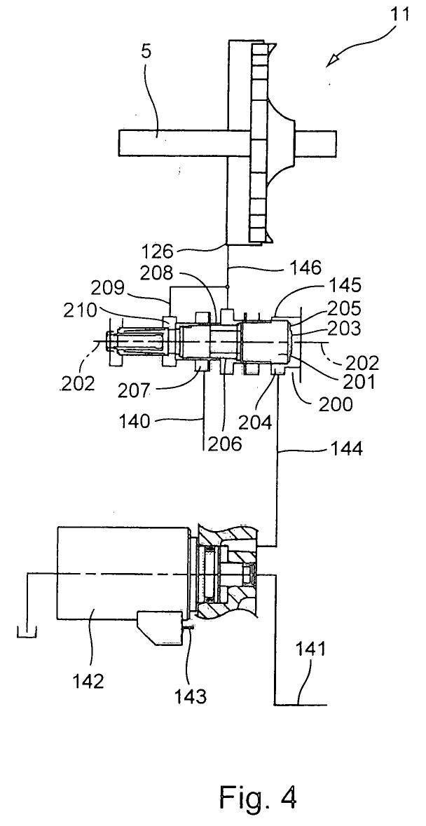

FIG. 4 shows an exemplary embodiment of a pressure supply to the hydraulic connection 126. In a hydraulic pressure line 140, a working pressure is established which is provided for example by a pump, which is driven by an engine and which conveys a hydraulic fluid out of a tank into the working pressure line. A (constant) low supply pressure is provided in a supply pressure line 141. The supply pressure line 141 is connected to an input of a solenoid valve 142. According to an electrical signal 143, the solenoid valve 142 generates a control pressure which forms the output of the solenoid valve 142 in a control pressure line 144. The control pressure can be varied within a predetermined interval according to the electrical signal 143.

The working pressure line 140 and the control pressure line 144 extend as inputs to a control spool valve 145. the control spool valve 145 processes the operating pressure and the control pressure in a way known per se into a control pressure, which is supplied to the hydraulic connection 126 via a control pressure line 146 (if appropriate, with return to the control spool 145). By means of the hydraulic circuit illustrated in FIG. 4, an electrical signal predetermined by a control device can be converted into a proportional hydraulic pressure signal.

The control spool valve 145 has a casing 200, in which a control spool 201 is guided axially displaceably in the direction of an axis 202-202. The control pressure 144 acts in a control pressure space 203 on one end face of the control spool 201. For this purpose, the control spool valve 145 has an annular groove 204, which extends radially around the control spool 201 and which is connected to the control pressure line 144. Between the control pressure space 203 and the annular groove 204, an outflow cross-section is provided which can be closed or reduced by means of a control edge 205 of the control spool 201, depending on the position of the control spool 201.

Furthermore, the control spool valve 145 includes a control pressure space 206, which is connected hydraulically to the control pressure line 146. An annular space 207 is in communication with the working pressure line 140. A control edge 208 controls the outflow from the annular space 207 into the control pressure space 206, and the outflow cross-section can be closed completely or can be partially opened, depending on the position of the control spool 201.

The control fluid is returned from the control pressure line 146 to a bypass space 210 via a bypass line 209. In the bypass space 210, the returned control pressure fluid acts on an end face of the control spool 201 in such a way that a force resultant dependent on the returned control fluid pressure remains. An end face of the control spool 201, which is located opposite the control pressure space 203 serves for supporting the control spool with respect to the casing 200, with the potential energy accumulator, in particular a compression spring, being interposed.

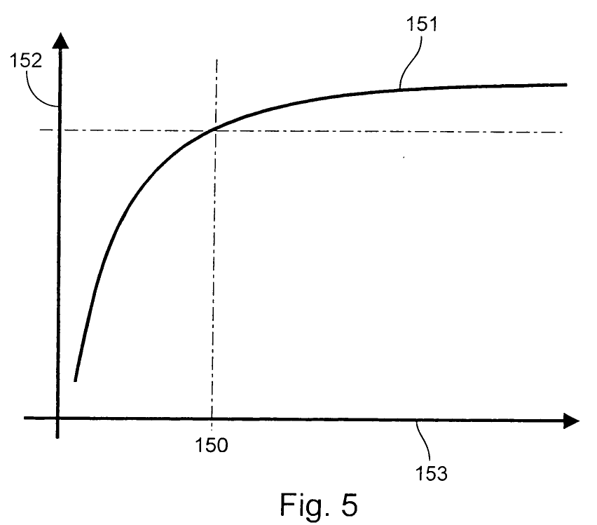

FIG. 5 shows the profile of a coefficient of friction of a traction medium, at the same time indicating the coefficient of friction 152 against the pressure force or normal force 153 between the toroidal disks 11, 16 or 17, 12 and the assigned roller 13 or 15. Below a critical pressure force 150 (“glass transition”), the friction characteristic curve 151 falls rapidly to low values, above the critical pressure force, there are high coefficients of friction at an approximately constant level.

For the design of the operating points and for dimensioning the spring elements 132, 133, traction performance graphs, as they are referred to, for the individual traction media are known, cf., for example:

S. Aibara, S. Natsumeda, H. Achiha: EHL Traction in traction drives with high contact pressure. Research and development center, NSK Ltd., 1-5-50 Kugenuma-Shinmei, Fujisawa, Kanagawa, Japan.

The friction characteristic curve illustrated in FIG. 5 is variable in terms of operating conditions. In particular, the critical pressure force 150 is dependent on operating parameters, for example the circumferential speed of the traction bodies, fluctuation magnitudes in the operating conditions, an engine start or the temperature of the traction medium. Conventional design methods determine the critical pressure force 150 for all or a plurality of the possible operating conditions. The actual design takes place with a safety margin over the critical pressure force 150 thus determined. In contrast to this, according to the invention, the critical pressure force 150 is determined without, or with, the reduced safety margin and/or only in optimized operating ranges, and the basic pressure exerted by the spring element 130, 134 is designed in such a way that the critical pressure force is provided by the spring element 133, 134 at most in selected operating states. A further pressure force necessary in further operating states as a result of a displacement in the critical pressure force 150 is provided by the hydraulic system.

The pressure force made available by the potential energy accumulator preferably amounts to 700 N/mm², 1500 N/mm² or 1800 N/mm², according to which the spring element 132, 133 is selected. The maximum pressure force in this case amounts to approximately 4000 N/mm².

1. A variable speed transmission including a continuously variable toroidal drive arranged in the force flux between an input shaft (5) and an output shaft (6), said toroidal drive having at least
a) one driving toroidal disk (11, 12),
b) one driven toroidal disk (16, 17),
c) one roller (13, 15), which is compressed between the driving and the driven toroidal disks (11, 12; 16. 17) with a continuously variable transmission ratio,
d) at least one toroidal disk (11) being mounted so as to be axially displaceable along an axis 52-52, of the input and output shafts (5,6),
e) the displaceable toroidal disk (11) being subjectable to at least part of a pressure force by means of a hydraulic piston and a hydraulic pressure acting on a piston surface thereof,
f) the hydraulic pressure being the control pressure of a control spool valve (145),
g) an operating pressure (140) and a control pressure supplied to the control spool valve (145),
h) the control pressure (144) being provided by a solenoid control valve (142), and
i) the control pressure (144) and the control pressure acting on the end faces of the control spool (201) in opposite directions for actuating the control spool.

2. The variable speed transmission as claimed in claim 1, wherein the control spool valve (145) has two control edges.

3. The variable speed transmission as claimed in claim 1, wherein a spring device (spring 132, spring 133) is provided so as to apply at least part of the pressure force at least in part-operating ranges of the variable speed transmission in a parallel arrangement connection with the hydraulic pressure.

4. The variable speed transmission as claimed in claim 1, wherein the hydraulic pressure is effective directly on the toroidal disk (11).

5. The variable speed transmission as claimed in claim 4, wherein a pressure space (123) is formed by the toroidal disk (11) forming the displaceable piston (118) and a working cylinder (117) of an intermediate carrier (111), receiving the piston (119) and forming the pressure space (123) to which hydraulic pressure fluid can be supplied.

6. The variable speed transmission as claimed in claim 5, wherein the intermediate carrier (111) is mounted axially non-displaceably with respect to the axis (52-52).

7. The variable speed transmission as claimed in claim 5, wherein the intermediate carrier (111) is mounted axially displaceably with respect to the axis (52-52) under the action of a spring (133).

8. The variable speed transmission as claimed in claim 5, wherein a spring (132) applying part of the pressure force is arranged in the pressure space (123).

9. The variable speed transmission as claimed in claim 1, wherein the hydraulic pressure is fed back to the control spool of the control spool valve (145).
